(19) United States
(12) Patent Application Publication
(10) Pub. No.: US 2013/0229290 A1
(43) Pub. Date: Sep. 5, 2013

(54) INSTRUMENT PANEL BUS INTERFACE

(71) Applicant: Phillip Andrew Bahorich, Laguna Hills, CA (US)

(72) Inventor: Phillip Andrew Bahorich, Laguna Hills, CA (US)

(73) Assignee: Eaton Corporation, Cleveland, OH (US)

(21) Appl. No.: 13/410,119

(22) Filed: Mar. 1, 2012

(51) Int. Cl. G01C 23/00

(52) U.S. Cl. 340/971

(57) ABSTRACT

An instrument panel including a plurality of user interface components respectively configured to receive or generate an electrical signal and one or more electronic apparatus, such as a bus expander, configured to exchange data between the plurality of electronic user interface components and a bus. With embodiments, the instrument panel is configured without a microprocessor or a micro-coded component coupled to the bus.

### BACKGROUND

1. Technical Field

The present disclosure relates to the exchange of data over a bus, including instrument panels configured to exchange data over a bus, without requiring the provision of software or micro-coded components in the instrument panel.

2. Description of the Related Art

Instrument panels developed for aircraft several decades ago required a number of wires to connect user interface components in the panel (such as switches and indicator lights) to electrical, mechanical, or other associated components. The advent of the digital computer and data bus enabled a multitude of such wires to be replaced by one or two sets of twisted-shielded pairs thus, inter alia, reducing aircraft weight attributable to wiring, including wire harnesses, connectors, and the wires themselves. Conventional aircraft digital data busses generally require a computer or similar electronically coded device on each end of the bus to convert the data bus signals into a usable format to drive digital displays, monitor switch positions, cause lights to illuminate, etc.

As the complexity and importance of computers and software used on aircraft increased, aircraft certification authorities (e.g., the FAA) adopted strict standards for development, testing and certification of software used in aircraft to help improve safety and reliability. One such standard is RTCA DO-178B, which is applied today by many aircraft certification authorities. However, RTCA DO-178B and similar standards can make aircraft software comparatively much more expensive to develop than commercial software. For some applications, instrument panels and other devices communicating over digital data busses began to include custom micro-coded components such as Field Programmable Gate Arrays (FPGAs), Programmable Logic Devices (PLDs), and Application Specific Integrated Circuits (ASICs). Because FPGAs, PLDs, ASICs, and other custom micro-coded components do not include software for the purposes of compliance with RTCA DO-178B standards.

As custom micro-coded components became as significant and complex as custom software, certification authorities began to also require certification of custom micro-coded components. For example, RTCA DO-254 was developed so that similar standards now apply to software and custom micro-coded components. Consequently, custom micro-coded components can now, like software, be very expensive to develop, test, and certify for aircraft applications.

The present disclosure seeks to address one or more of the above-identified challenges.

### SUMMARY

An instrument panel according to the present invention can overcome challenges associated with the prior art—e.g., the costs of designing, testing, and certifying software and/or custom micro-coded components—while still providing bus-based communication capabilities that are desirable. An embodiment of such an instrument panel may comprise a plurality of user interface components, respectively configured to receive and/or generate an electrical signal, and a bus expander. The bus expander can be electrically coupled to one or more of the plurality of user interface components, and may be configured to exchange data between one or more of the plurality of user interface components and a bus configured for non-packet-based communication. In an embodiment, the bus may include an I²C bus. In other embodiments, the bus may include an SMBus, an SPI bus, a 1-Wire bus, and/or another type of serial bus.

In embodiments, an instrument panel can include a plurality of user interface components respectively configured to receive and/or generate an electrical signal and one or more electronic apparatus configured to exchange data between the plurality of electronic user interface components and a bus. The instrument panel may intentionally not provide a microprocessor or a micro-coded component coupled to the bus.

The foregoing embodiments of an instrument panel can be included in a system for exchanging data. The system can also include a bus and a master data controller coupled to the bus. Each component disposed in the instrument panel that is electrically coupled to the bus can comprise a portion of a slave node on the bus.

Additional disclosures are provided and illustrated in the following sections and Figures.

### BRIEF DESCRIPTION OF THE DRAWINGS

Embodiments of the invention will now be described, by way of example, with reference to the accompanying drawings, wherein:

FIG. 1 generally illustrates a diagrammatic view of an embodiment of an instrument panel, such as might be found in an aircraft cockpit.

FIG. 2 generally illustrates a block diagram view of an embodiment of a system for exchanging data between an instrument panel and a plurality of components that are controlled and/or monitored from the instrument panel.

FIG. 3 generally illustrates a diagrammatic view of an embodiment of a data distribution system including an instrument panel similar to the instrument panel of FIG. 1.

### DETAILED DESCRIPTION

Reference will now be made in detail with respect to embodiments of the present disclosure, examples of which are described herein and illustrated in the accompanying drawings. While concepts will be described in conjunction with embodiments, it will be understood that the invention is not intended to limit the specific disclosures associated with the embodiments. On the contrary, the invention is intended to cover alternatives, modifications and equivalents, which may be included within the spirit and scope of the invention as defined by the appended claims.

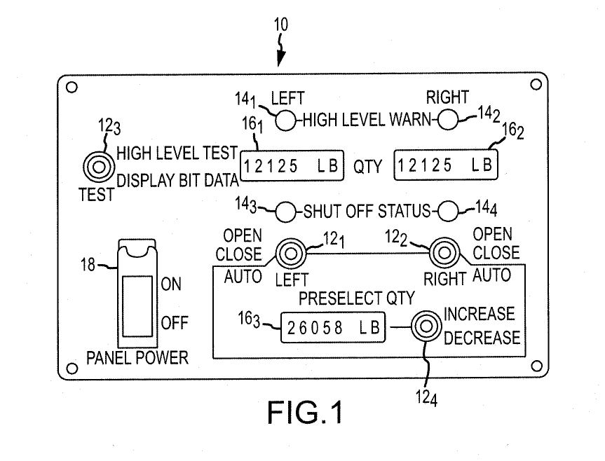

FIG. 1 generally illustrates a diagrammatic illustration of an embodiment of an instrument panel 10. Such a panel 10 may be used, for example only, in connection with an aircraft cockpit control panel. The illustrated instrument panel 10 illustrates several user interface components, including a plurality of switches 12, a plurality of indicator lights 14, a plurality of multi-character displays 16, and a panel power switch 18. In embodiments, such an instrument panel 10 may be a fuel-related instrument panel, a panel containing instruments for other purposes in an aircraft (e.g., electrical power, external hydraulics, bleed air or air conditioning, etc.), an instrument panel in another vehicle, such as a passenger automobile, truck, industrial or agricultural vehicle, or watercraft, or an instrument panel in a non-vehicular system or machine.

For example, without limitation, an embodiment of the instrument panel 10 may find use in an aircraft cockpit such as, for example, a fuel-related instrument panel. In the embodiment illustrated in FIG. 1, two displays 16₁ and 16₂ may be provided for monitoring the fuel levels in left and right fuel tanks, respectively, and a third display 16₃ may be provided for displaying the current preselected fuel quantity for automatic refueling. First and second indicator lights 14₁, 14₂ can be provided as high level warning indicators for the right and left fuel tanks, respectively, and third and fourth indicator lights 14₃, 14₄ can be provided for monitoring the valve shut off status of the left and right tanks, respectively. In the embodiment, four toggle switches may be included: first and second toggle switches 12₁, 12₂ for control of valves in the left and right fuel tanks, respectively, a third toggle switch 12₃ for testing various components on the instrument panel 10, such as the high level fuel indicator lights 14₁, 14₂, and a fourth toggle switch 12₄ for increasing and decreasing the preselected fuel quantity for automatic refueling shown in display 16₃. The panel power switch 18 may control the supply of power to the switches 12, the indicator lights 14, the displays 16, and/or, as desired, one or more backlights for the instrument panel 10.

Switches 12, indicator lights 14, and displays 16 may comprise one or more of various user interface components on the instrument panel 10 that are configured to receive and/or generate respective electrical signals. Such user interface components may be any of various components known in the art. For example, in an embodiment, the indicator lights 14 can be light-emitting diodes (LEDs), and the displays 16 can be 8-digit 5×7 pixel dot matrix displays. Of course, other types of lights and displays and other types of user interface components may be included in connection with different embodiments of the instrument panel 10.

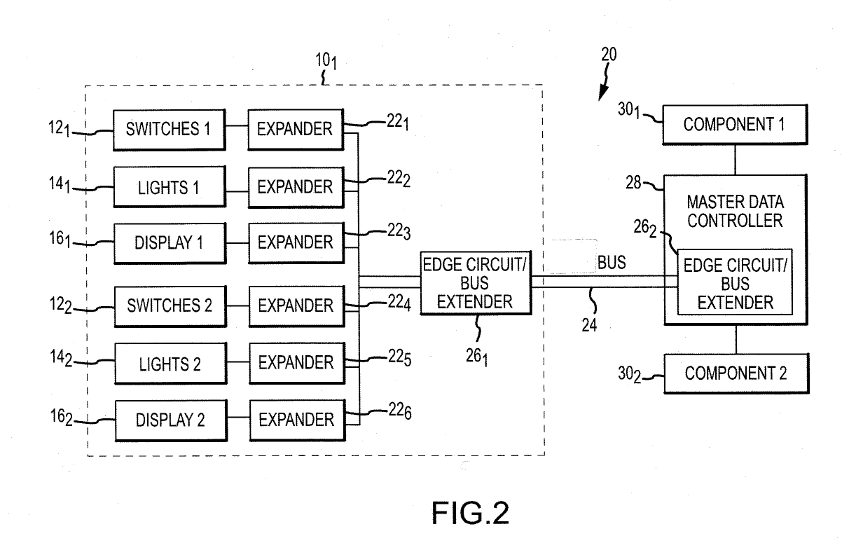

FIG. 2 generally illustrates a block diagram view of an embodiment of a system 20 for exchanging data. The illustrated system 20 includes an embodiment of an instrument panel 10₁, which itself may include one or more switches 12, indicator lights 14, displays 16, bus expanders (or bit expanders) 22, and an edge circuit/bus extender 26₁. The system 20 may further include a bus 24, a master data controller 28 (itself including an edge circuit/bus extender 26₂), and/or a number of non-panel components 30.

The following embodiment of the system 20 will be described with reference to an aircraft application. However, it should be understood that the system 20 may be broadly applicable and need not be limited to an aircraft environment. Rather, embodiments of such a system 20 may also find uses in other vehicles, systems, and machines.

In an aircraft-related embodiment, non-panel components (e.g., 30₁ and 30₂) may be associated with flight control surfaces (e.g., flaps and rudders), portions of a bleed air system, air conditioning, portions of a fuel system or fuel management system, or portions of some other system that can be controlled and/or monitored from a remote panel (e.g., a cockpit instrument panel). In non-aircraft embodiments, each non-panel component may comprise one or more electrical, mechanical, hydraulic, or other components capable of being controlled and/or monitored from a separate panel.

In an embodiment, switches 12, indicator lights 14, and displays 16 may be used to control and/or monitor non-panel components 30. For example, a first set of switches 12₁ may be used to actuate various portions of a first non-panel component (e.g., 30₁), and a first set of indicator lights 14₁ and a first display 16₁ may output information relevant to that actuation. A similar relationship may exist for a second set of switches 12₂, second set of indicator lights 14₂, second display 16₂, and a second non-panel component (e.g., 30₂).

A bus 24 can be provided for the exchange of data between a master data controller 26 and an instrument panel 10₁. In conventional systems, the bus 24 generally contemplates the use of software or micro-coded components on both sides of the bus—i.e., both in the master data controller 28 and in the instrument panel 10₁. Embodiments of the disclosed system 20 can, inter alia, eliminate the need for software or micro-coded components in the instrument panel 10₁. As a result, embodiments of an instrument panel 10₁ may, as desired, be configured to be simpler than known instrument panels without sacrificing bus-based communication functionality offered by known instrument panels.

With embodiments of an instrument panel 10₁, a bus 24 may be configured to transmit data in a form or format that allows for communication with relatively simple components in the panel 10₁. For example, a bus 24 may comprise an Inter-Integrated Circuit (I²C) bus; another bus type based on I²C communication such as a System Management Bus (SMBus), a Serial Peripheral Interface (SPI) bus, a 1-Wire bus, or various similar busses known in the art. The descriptions of data exchange in the remainder of this disclosure are based on I²C communication, with the understanding that one of skill in the art would be able to apply the teachings of this disclosure to similar communications protocols. Although I²C and similar busses are generally known in the art, a brief discussion of the operation of an I²C bus follows.

An I²C bus is master/slave serial digital bus that can support multiple master nodes and/or multiple slave nodes. Each slave node or device generally has a unique address on the bus. Communication between a master device and one or more slave devices may be initiated by the master device. To initiate communication with a slave device, the master device transmits a signal indicating that it wishes to open communication, followed by a signal containing the address of the slave device. In general, once the slave device acknowledges the opening of communication, communication between the master and slave device begins. As a result, slave devices may only be able to write to the bus 24 when prompted by a master device. The master device can also open communication with multiple slaves simultaneously in certain circumstances and/or under certain conditions.

Physically, an I²C bus may comprise two data lines: a Serial Data Line (SDA) and a Serial Clock Line (SCL). In general, bits are transmitted on the SDA as square waves representing logical ones and zeroes, and a clock on the SCL is driven in square wave format as well. Accordingly, I²C communication can be dependent on recognizable square waves so that components reading data from the bus can properly recognize the timing and contents of data signals.

In general, I²C busses and similar serial and parallel master/slave busses generally find use in short-distance applications, such as transmitting data between components within a computer, such as processors, memory, etc. One reason for a distance limitation is that the capacitance associated with I²C busses, over a long transmission line, may degrade a transmitted signal such that the transmitted signal eventually appears sinusoidal, rather than square, and may be less likely to be properly interpreted by a receiving device.

Embodiments of the disclosed system 20 include features that can serve to overcome a distance-based signal decay that may be typical of I²C and similar busses. First, the components in communication with the bus 24, such as the instrument panel 10₁ and the master data controller 28, may be provided with one or more edge circuits/bus extenders 26. Each edge circuit/bus extender 26 can include edge circuit functionality to determine, inter alia, where an incoming signal transitions from high-to-low, and/or from low-to-high, and restore a proper edge at that point in the signal—i.e., sharpen the signal to a square wave. As a result, even if a data signal does not comply completely with I²C specifications along the entire length of the bus 24, the signal can be restored to the proper form to meet I²C specifications at its interface with the instrument panel 10₁. Additionally or alternatively, each edge circuit/bus extender 26 can include bus extender functionality to, inter alia, buffer the SDA and SCL lines and/or allow for a larger total bus capacitance such that a transmitted signal does not decay in as short a distance as in a typical I²C bus. In an embodiment, an edge circuit/bus extender 26 can comprise a P82B715 I²C bus extender, commercially available from NXP Semiconductors.

A second feature that may be incorporated into the bus 24 to help overcome potential signal decay is the selection of a proper/desirable transmission frequency. I²C busses generally carry data at 100 kHz (i.e., 100 kilobits per second), though faster and slower speeds are possible. At lower transmission frequencies, the proportional effect of transmission line capacitance—i.e., the decay of a transmitted signal—can be less severe. Accordingly, in embodiments, the bus 24 may be configured for data transmission at about 12.5 kHz. The transmission frequency may be chosen according to, inter alia, the capabilities of the edge circuit/bus extenders 26. For example, a lower transmission frequency may be chosen for use with edge circuits, while higher transmission frequencies may be chosen for use with bus extenders. In an embodiment of the system 20 in which at least one edge circuit/bus extender 26 is a bus expander, the bus 24 may be configured for transmission at, for example only, 100 kHz or 400 kHz. Of course, other transmission frequencies, both higher and lower, on the bus 24 are possible and contemplated, as are other combinations of transmission frequencies and embodiments of edge circuit/bus extenders 26.

The master data controller 28 can be configured for translating input from the instrument panel 10₁ into actuation of one or more non-panel components (e.g., 30₁ or 30₂), for translating conditions of the non-panel components into output on the instrument panel 10₁, and for other functions. The master data controller 28 can be configured to perform all calculations and include all decision-making electronics with respect to the data generated for output to the instrument panel 10₁ and the data generated as input at the instrument panel 10₁. Accordingly, the master data controller 28 can include one or multiple computing/processing apparatus, and can include an electronic control unit with customized software and/or customized hardware.

The master data controller 28 may be configured to transmit and receive data in one or more of the bus formats or protocols noted above such as, for example only, I²C, SMBus, SPI, or 1-Wire. Furthermore, in an embodiment, the master data controller 28 may act as a master device (or the sole master device) on the bus 24, such that all other devices exchanging data over the bus 24 are slave devices. Accordingly, in an embodiment, the master data controller 28 may be configured to operate in master transmit mode, master receive mode, and/or any other modes supported by a particular protocol. In an embodiment, these modes may include the capability to initiate communication with one or more slave devices. For example, the master data controller 28 may be configured to transmit a “start” bit to one or more slave devices, then an indication of whether the master data controller wishes to read to the slave device(s) or read from the slave device(s). Based on whether the master data controller 28 wishes to read or write, the master data controller may be configured to then enter master write mode or master receive mode.

Because the bus 24 is provided with features to contemplate and/or counteract signal decay that may be associated with I²C and similar busses, the bus 24 can be used to transmit data over relatively long distances. In other words, the master data controller 28 and the instrument panel 10₁ can be placed some distance away from one another within the system 20. In an embodiment, the master data controller 28 may be located about 15 feet or more away from the instrument panel 10₁. In a further embodiment, the master data controller may be located about 150 feet, 300 feet, or more away from the instrument panel 10₁. An appropriate distance between the master data controller 28 and the instrument panel 10₁ can be determined according to, inter alia, the transmission frequency used on the bus 24 and the particular embodiment(s) chosen for each edge circuit/bus extender 26. In an embodiment, edge circuits may be used at each end of the bus 24 (i.e., each of edge circuit/bus extenders 26₁, 26₂ comprises an edge circuit), the bus 24 may be configured for data transmission at 12.5 kHz, and the master data controller 28 may be located up to about 300 feet from the instrument panel 10₁. In another embodiment, bus extenders may be used at each end of the bus 24 (i.e., each of edge circuit/bus extenders 26₁, 26₂ comprises a bus extender), the bus 24 may be configured for data transmission at between about 100 kHz and about 400 kHz, and the master data controller 28 can be located up to about 150 feet from the instrument panel 10₁. Of course, these combinations of transmission frequencies, edge circuit/bus extender embodiments, and distances are exemplary only, and other combinations are contemplated.

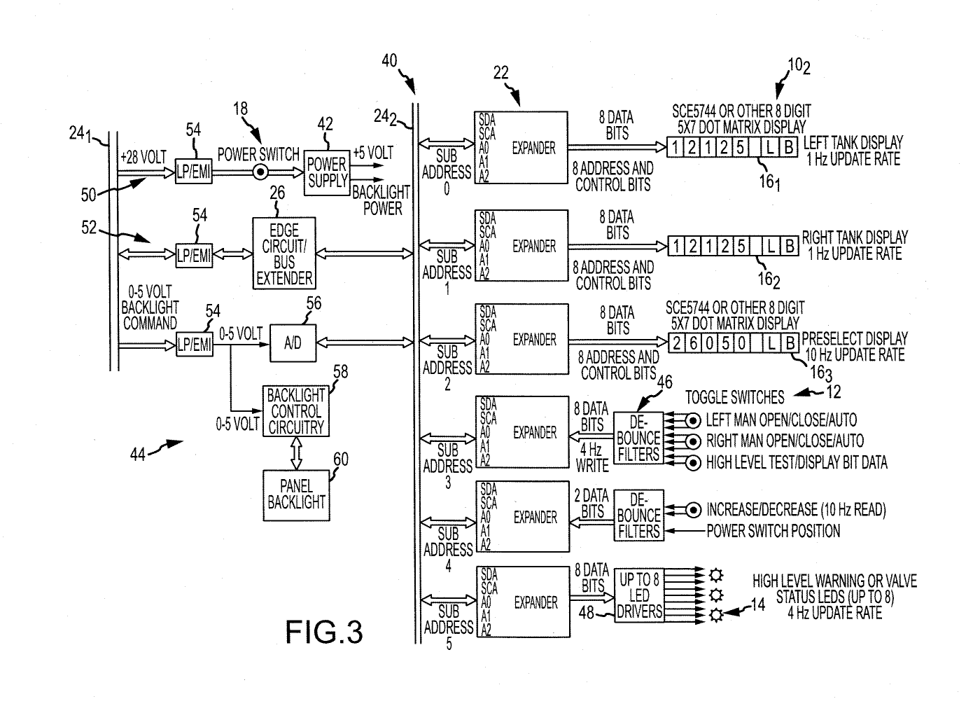

As mentioned above, the instrument panel 10₁ can be provided without software or micro-coded components for communication over the bus 24. However, the instrument panel 10₁ may still include relatively simple electronics—for example, to exchange data between the bus 24 and the switches 12, the indicator lights 14, the displays 16, and other user interface components. In an embodiment, one or more bus expanders 22 may be provided for that purpose—i.e., to translate data on the bus 24 into output on one or more user interface components (e.g., indicator lights 14 and displays 16) and to translate input on one or more user interface components (e.g., switches 12) into data on the bus 24. If desired, the bus expanders 22 may be off-the-shelf components known in the art and configured for the particular protocol used on the bus 24. For example, a bus expander 22 may be a PCA9534A Remote 8-bit I²C Expander, commercially available from Texas Instruments, or its equivalent, or a PCA9535 Remote 16-bit I²C Expander, commercially available from Texas Instruments, or its equivalent. Of course, each bus expander 22 may comprise other components as well. In general, the bus expanders 22 and user interface components 12, 14, 16 in the instrument panel 10₁ can be configured as slave nodes or devices on the bus 24. As a result, the bus expanders 22 and user interface components 12, 14, 16 may act only under the direction of the master data controller 28. Further detail regarding an embodiment of bus expanders 22 in communication over the bus 24 is described in conjunction with FIG. 3.

FIG. 3 generally illustrates a schematic and block diagram view of an embodiment of a system 40 for exchanging data. The illustrated system 40 includes many components similar to those associated with FIGS. 1-2. As a result, the descriptions of those components will not be entirely repeated. However, it should be understood that previous descriptions of the same or similar components may apply equally to FIG. 3, unless additionally noted. The system 40 may include an embodiment of an instrument panel 10₂, including a plurality of switches 12, a plurality of indicator lights 14, a plurality of displays 16, and a plurality of bus expanders 22. Though shown separately, a panel power switch 18 also may be incorporated into the instrument panel 10₂. The system 40 may also include a bus 24, a power supply 42, and/or a backlight circuit portion 44.

Like the embodiments of instrument panels 10 and 10₁ included in FIGS. 1 and 2, the instrument panel 10₂ may be included in a part of an aircraft cockpit control panel. And, like the instrument panel 10 illustrated in FIG. 1, an instrument panel 10₂ of the type generally illustrated in FIG. 3 may find use with, for example and without limitation, fuel control and/or monitoring. Accordingly, the switches 12, indicator lights 14, and displays 16 may be provided for the control and monitoring of fuel levels and valves in fuel tanks.

Because the user interface components 12, 14, 16 provided on the instrument panel 10₂ may have different purposes with different relative levels of importance, the refresh rates of the components—i.e., the frequency with which the master data controller reads data from or writes data to a component—may differ. For example, as generally shown, the first and second displays 16₁, 16₂ may each refresh at a rate of 1 Hz. The third display 16₃, however, may be configured to refresh at a higher rate of 10 Hz so that a user can more accurately select a refueling volume. For the same reason, the master data controller may be configured to read the increase/decrease switch 12₄ at a rate of 10 Hz. In addition, to ensure that a user is timely notified of the status of the fuel tanks, the indicator lights 14 may be updated by the master data controller at a rate of 4 Hz. Of course, the refresh rates identified are exemplary only. Other refresh rates, either faster or slower, may be used for any of the user interface components 12, 14, 16, and other user interface components on the instrument panel 10₂.

In an alternate embodiment, one or more outputs (e.g., indicator lights 14 or displays 16) may be linked to a related input (e.g., one or more switches 12) by logic circuitry within the panel 10₂, for instance, to provide for faster updating of the output, to reduce the processing power required for the master data controller, and/or to reduce traffic on the bus 24. For example, in an embodiment, a third display 16₃ may be electrically coupled to a digital logic increment/decrement counter circuit inside the panel 10₂ that can be configured to drive the displayed value up or down based on input on an increase/decrease switch 12₄. The master data controller could then read the resulting display value. Such a configuration could allow the increase/decrease switch updates and preselect display updates to take place at a lower speed (i.e., would require less frequent refreshing over the bus 24), which could save computer processing time and reduce the amount of bus communication required. It should be noted that, with such an embodiment, the instrument panel 10₂ still need not contain a processor, software, or micro-coded components configured for bus communication.

The instrument panel 10₂ contains several components not shown in connection with prior embodiments of instrument panels 10, 10₁. Switches 12 may be electrically coupled to de-bounce filters 46. As known in the art, the de-bounce filters 46 may filter bouncing (i.e., analog) noise out from the mechanical movement of the switches 12 to supply digital signals for transmission. Additionally, the indicator lights 14 may be driven by a set of LED drivers 48. Both the de-bounce filters 46 and the LED drivers 48 may, if desired, comprise conventional components that are generally known in the art.

As illustrated, the user interface components—e.g., switches 12, indicator lights 14, and/or displays 16—can interface with the bus 24 for data exchange through a number of bus expanders 22. Each bus expander 22 may, for example and without limitation, have five or more inputs, including a serial data input SDA, a serial clock input SCA, and three address bits A0, A1, A2. Each bus expander 22 may be assigned a sub-address on the bus 24. In a further embodiment, each sub-address may be unique. In the illustrated embodiment, each bus expander 22 can, for example, be configured to read up to 8 or 16 bits of data from the bus 24 for a single output, or read up to 8 or 16 bits of data from a single input for writing to the bus 24. Each of the bus expanders 22 may be configured as a slave node on the bus 24. As a result, each of the user interface components—i.e., the switches 12, indicator lights 14, and/or displays 16—may comprise at least a portion of a slave node on the bus 24.

In an embodiment, neither the bus expanders 22 nor any other component in the instrument panel 10₂ that is electrically coupled to the bus 24 contains sufficient data storage for packet-based communication over the bus 24. In such an embodiment, the instrument panel 10₂ may not be configured for packet-based communication. Accordingly, both the bus 24 and the master data controller may be configured for non-packet-based communication. For example, each individual transmission between a master device (i.e., the master data controller) and one or more slave devices may include only a few bits or even a single byte.

The bus 24 is shown as a main bus portion 24₁ and a panel bus portion 24₂. Several signal paths are electrically coupled to the main bus portion 24ₖ, including a main power signal path 50, a user interface component data path 52, and the backlight circuit portion 44. A master data controller (e.g., shown in FIG. 2) may also be electrically coupled to the main bus portion 24₁ as a master node. If desired, the master data controller may be configured to perform all calculations necessary to drive the output of the indicator lights 14 and/or displays 16, as well as the calculations necessary to convert the state of the switches 12 into meaningful output (e.g., the opening or closing of a valve or the increase or decrease of the preselected refueling level).

In an embodiment, a backlight circuit portion 44, main power signal path 50, and user interface component data path 52 may each include a lightning protection/electromagnetic interference (LP/EMI) filter 54 to reduce electromagnetic interference at the input to the instrument panel 10₂ and protect the various electrical components of the instrument panel 10₂ from lightning-based and other voltage and current spikes. The LP/EMI filters 56 can comprise various filters known in the art.

A main power signal path 50 can route power from the main power source of the system 40 to the instrument panel 10₂. In an embodiment, the main power source of the system 40 may be an aircraft power supply providing power at 28 V. Accordingly, the main power signal path can be provided with a power supply 42—e.g., a direct current to direct current (DC-DC) converter—to provide power at the voltage appropriate for the respective instrument panel 10₂. In an embodiment, for example, the power supply 42 can supply power at 5 V.

If desired, a backlight circuit portion can include an LP/EMI filter 54, an analog-to-digital (A/D) converter 56, backlight control circuitry 58, and/or a panel backlight 60. The A/D converter 56 may translate an analog backlight command into a digital signal readable by a master data controller. In an embodiment, the analog backlight command may be an analog signal having an amplitude between about 0 V and about 5 V. The master data controller can then determine how bright the displays 16 should be, and include a brightness value in the control bits transmitted to the displays 16 (i.e., transmitted to an appropriate bus expander 22). The backlight control circuitry 58 also may use the analog backlight command to set the brightness of the panel backlight 60. The panel backlight 60 may comprise a single light source, or multiple light sources, and the backlight control circuitry 58 may thus be configured to support a desired number of light sources. In an embodiment, the analog backlight command may also be used to set the brightness of the indicator lights 14.

In embodiments, a user interface component data pathway 52 can provide a data path between the main bus portion 24₁ and the panel bus portion 24₂ for data exchange between a master data controller and user interface components, such as switches 12, indicator lights 14, and displays 16. The user interface component data pathway 52 can include features previously described to correct signal decay on the bus 24. For example, the user interface component data pathway 52 may carry data according to the I²C protocol at about 12.5 kHz, rather than standard 100 kHz. In such an embodiment, both portions 24₁, 24₂ of the bus 24 may also transmit data at about 12.5 kHz. In addition, the user interface component signal pathway 52 can include an edge circuit/bus extender 26 for, e.g., restoring the square wave form for data transmitted over the bus 24, buffering data transmitted on the bus 24, and/or allowing for a larger total bus capacitance, such that data can be received in a recognizable digital format. As a result, data on the panel side of the edge circuit/bus extender 26 (i.e., to the right of the edge circuit 26 in FIG. 3) may comply with I²C specifications, though data on the main bus side of the edge circuit/bus extender 26 (i.e., to the left of the edge circuit 26 in FIG. 3) may not comply. As noted above, this arrangement allows the bus 24 to transmit data over longer distances than would typically be possible with an I²C bus or similar bus.

The system 40 illustrated in FIG. 3 does not need to include any microprocessors, software, or micro-coded components such as FPGAs, PLDs, and ASICs on the panel side of the bus 24 that are configured for communication over the bus 24. As noted above, the computation behind the output shown on the instrument panel 10₂ can all be performed outside of the panel 10₂ in, for example only, a master data controller. As a result, each device within the panel 10₂ electrically coupled to the bus 24 may be configured as a slave device, and may be configured for non-packet-based communication. The bus 24 itself and the master data controller may similarly be configured for non-packet-based communication. Such a configuration of the system 40 can result, inter alia, in an instrument panel 10₂ with significantly simpler components than in known instrument panels with bus-based communications. The instrument panel 10₂ may therefore be less expensive to design (because extensive time is not required to customize software and micro-coding for the panel 10₂) and can be faster to market (because testing and certification to comply with particular government regulations is not needed).

The drawings are intended to illustrate various concepts associated with the disclosure and are not intended to limit the claims. A wide range of changes and modifications to the embodiments described above will be apparent to those skilled in the art, and are contemplated. For example, in an embodiment, all of the devices and components illustrated in the system 40 of FIG. 3 can be included in an instrument panel. An instrument panel as described herein can be located in, for example, an aircraft cockpit, elsewhere in an aircraft, or in another vehicle, system, or device. Additionally, even though specific models of particular components are named herein, those models are exemplary only. It is therefore intended that the foregoing detailed description be regarded as illustrative rather than limiting, and that it be understood that the following claims, including all equivalents, are intended to define the spirit and scope of this invention.

What is claimed:

1. An instrument panel comprising:
a plurality of user interface components respectively configured to receive or generate an electrical signal; and
a dedicated bus expander electrically coupled to one or more of the plurality of user interface components;
wherein the bus expander is configured to exchange data between the one or more of the plurality of user interface components and a bus configured for non-packet-based communication.

2. The instrument panel of claim 1, wherein the bus expander is configured to exchange data on an Inter-Integrated Circuit bus.

3. The instrument panel of claim 1, wherein the bus expander is configured to exchange data on a 1-Wire bus.

4. The instrument panel of claim 1, further comprising multiple bus expanders, wherein each of said bus expanders has a unique address on the bus.

5. The instrument panel of claim 1, wherein said instrument panel comprises a portion of an aircraft cockpit control panel.

6. The instrument panel of claim 1, wherein the plurality of user interface components includes one or more of a light-emitting diode and a toggle switch.

7. The instrument panel of claim 1, wherein each user interface component that is configured to receive or generate an electrical signal disposed in said instrument panel is configured to exchange data over a single bus configured for non-packet-based communication.

8. A system for exchanging data, comprising:
a bus;
an instrument panel comprising a plurality of user interface components electrically coupled to the bus; and
a master data controller coupled to the bus;
wherein each component disposed in the instrument panel that is electrically coupled to the bus comprises a portion of a slave node on the bus.

9. The instrument panel of claim 8, wherein the bus is configured to exchange data at a rate of about 400 kilobits per second or less.

10. The instrument panel of claim 9, wherein the bus is configured to exchange data at a rate of about 12.5 kilobits per second or less.

11. The system of claim 8, wherein the instrument panel is disposed in an aircraft cockpit.

12. The system of claim 8, wherein the instrument panel is located at least 50 feet from the master data controller.

13. The system of claim 12, further comprising an electronic circuit portion, coupled to the bus between the master data controller and the instrument panel, configured to reduce or correct signal decay of a digital signal on the bus.

14. The system of claim 13, wherein the bus is an Inter-Integrated Circuit bus.

15. An instrument panel comprising:
a plurality of user interface components respectively configured to receive or generate an electrical signal; and
one or more electronic apparatus configured to exchange data between the plurality of user interface components and a bus;
wherein said instrument panel does not include a microprocessor or a micro-coded component coupled to the bus.

16. The instrument panel of claim 15, wherein each of the one or more electronic apparatus comprises a bus expander.

17. The instrument panel of claim 15, wherein each electronic user interface component disposed in the instrument panel is electrically coupled to the bus.

18. The instrument panel of claim 15, wherein each of the one or more electronic apparatus has a unique address on the bus.

19. The system of claim 15, wherein said instrument panel is disposed in a vehicle selected from the group consisting of:
a passenger automobile;
a truck;
a tractor;
a bulldozer;
an industrial vehicle;
an agricultural vehicle; and
a watercraft.

20. The system of claim 15, wherein said instrument panel is disposed in an aircraft.
